(19) United States
(12) Patent Application Publication
(10) Pub. No.: US 2025/0106692 A1
(43) Pub. Date: Mar. 27, 2025

(54) DEVICES AND METHODS FOR DEPLOYING IN-NETWORK COMPUTING IN CELLULAR NETWORKS

(71) Applicant: Huawei Technologies Co., Ltd., Shenzhen (CN)

(72) Inventors: Xun Xiao, Munich (DE); Artur Hecker, Munich (DE); Osama Abboud, Munich (DE)

(21) Appl. No.: 18/971,730

(22) Filed: Dec. 6, 2024

Related U.S. Application Data
(63) Continuation of application No. PCT/EP2022/065800, filed on Jun. 9, 2022.

(51) Int. Cl. H04W 28/18; H04W 28/06; H04W 28/08

(52) U.S. Cl. CPC H04W 28/18; H04W 28/06; H04W 28/0967

(57) ABSTRACT

A device having one or more processors and non-transitory computer readable memory including computer program code for managing a core network of a cellular network, wherein the computer program code causes the device to at least obtain configuration information of an application service, where the application service comprises an in-network computing service, and provide the configuration information to a network function entity of the core network, where the configuration information is associated with enabling the network function entity to instantiate one or more instances for performing the in-network computing service.

### CROSS-REFERENCE TO RELATED APPLICATIONS

This application is a continuation of International Application No. PCT/EP2022/065700, filed on Jun. 9, 2022, the disclosure of which is hereby incorporated by reference in its entirety.

### TECHNICAL FIELD

The present disclosure relates to the field of communications technology. For example, the present disclosure relates to devices and methods for deploying in-network computing (INC) in cellular networks.

### BACKGROUND

Traditionally, network devices of cellular (or mobile) networks are vendor-specific. Functionalities of the network devices (e.g., supported network protocols) are pre-installed. Conventional network devices are difficult to be upgraded after being deployed, because hardware chipsets onboard are statically designed and encapsulated in terms of pre-defined specifications. The specifications widely adopted in the field of mobile communication are developed by a standards organization named “the 3^{rd} Generation Partnership Project” (3GPP). Mobile networks that are in compliance with 3GPP specifications may also be named 3GPP networks, which may include fifth-generation (5G) and 6G mobile networks. The 5G mobile network may also be referred to as a 5G new radio (NR) network. In this disclosure, the terms of “cellular network”, “mobile network”, and “3GPP network” may be used interchangeably.

Edge computing refers to bringing data computation and storage closer to the sources of data. For supporting edge computing and edge application services (EAS) with a 3GPP network, an application architecture was proposed by 3GPP to allow application data traffic to travel from UE via a 3GPP core network to an edge data network (E-DN). The edge data network is internetworking with the 3GPP network. The edge data network may host one or more edge application servers adapted to process the application data. Further, European Telecommunications Standards Institute (ETSI) defined a network architecture named “Multi-access edge computing (MEC)” to enable cloud/edge computing capabilities at the edge of cellular networks.

### SUMMARY

Edge computing reduces the distance that data must travel. However, edge application services may bring an increasing volume of data traffic through a 3GPP network, especially in the 3GPP core network. Because some edge application services may cause UEs (or clients) to generate a massive amount of raw data, which will be processed at a corresponding application server deployed in an edge data network internetworking with the 3GPP network. The massive amount of raw data needs to travel through the 3GPP network to the corresponding application server. This may lead to a heavy traffic load in the 3GPP network and may cause network congestion in the 3GPP network. In addition, the round-trip latency may also degrade the user experience of the application service.

It is noted that the edge computing is generally an application service, or an edge application service. In this disclosure, the term of “application service” and “edge application service” may be used interchangeably.

In view of the above, this disclosure aims to optimize data traffic for application service(s) in a 3GPP network. Another objective of this disclosure is how to allow the management plane (MP) of the 3GPP network to support instantiating, in a 3GPP core network domain, a network function instance that contains a part or all of the application logic defined by an application service provider (ASP). The application logic may be used to fulfill the application service(s) and is supposed to be instantiated in edge application server(s) of the edge data network.

Further, it is unclear how to realize the in-network computing for application services in a mobile network, particularly in the core network of a 3GPP network. According to 3GPP, computational tasks (especially for user plane purposes) are considered application services supposed to be provided in a data network (DN), which is outside the domain of the 3GPP network. In other words, the 3GPP network only provides connectivity from UE to a data network or a multi-access edge computing system. If an application service provider wishes to deploy an in-network computing (or in-network application logic (IN-AL)) service for its own application, this is not supported by a current cellular network (e.g. 5G mobile networks). More specifically, this is not supported by the management plane of the 3GPP network.

In other words, current 3GPP networks lack of the support from the management plane to realize a network function containing the IN-AL deployed in the domain of the 3GPP networks. That is, conventionally, the application-specific computing logic can only reside at an edge data network, while only 3GPP-defined network functions that are standardized by 3GPP can be deployed in the 3GPP network domain. Due to this limitation, an application service cannot utilize the benefits of in-network computing in mobile networks.

These and other objectives are achieved by the solution of this disclosure as described in the independent claims. Advantageous implementations are further defined in the dependent claims.

A first aspect of this disclosure provides a management device for managing a core network of a cellular network. The management device is configured to obtain configuration information of an application service, in which the application service comprises an in-network computing service. Further, the management device is configured to provide the configuration information to a network function (NF) entity of the core network. The configuration information is adapted to enable the network function entity to instantiate one or more instances for performing the in-network computing service.

The in-network computing service in this disclosure may be understood as directly deploying an application-specific computing logic onto networking elements of a forwarding path, e.g., the network function entity. That is, the in-network computing service may be referred to as an offloading of an (edge) application service to run within the core network of the cellular network, e.g., a 3GPP core network. That is, the in-network computing service may be associated with the (edge) application service deployed in an (edge) data network.

This has the advantage that processing tasks can start much earlier (e.g., in the core network) before arriving at an endpoint where an actual application server locates (e.g., the edge data network). Further benefits of supporting the in-network computing in the core network of the cellular network may include reducing the traffic volume in the cellular network, reducing service latency (or round-trip latency), and improving resource utilization of the cellular network.

Optionally, the network function entity may comprise programmable network processing units (NPUs). The network function entity may be based on network function virtualization (NFV).

In an implementation form of the first aspect, the configuration information may comprise one or more of: a quantity of the one or more instances required for performing the in-network computing service; and identification information of the application service.

Optionally, the identification information of the application service may be an identity (ID) value associated with the (edge) application service deployed in the edge data network internetworking with the cellular network.

In this way, the in-network computing of the network function entity can be identified and linked to the associated (edge) application service. The cellular network may classify traffic data and redirect data that is related to the edge application service to a corresponding network function entity.

In an implementation form of the first aspect, the configuration information may further comprise topology information of two or more instances for the in-network computing service.

That is, when two or more instances are needed to achieve the in-network computing service, the configuration information may further indicate how the two or more instances shall be connected in order to form a particular service graph. The service graph may be a linear path, a tree, or a general graph. Optionally, the topology information may further carry link performance metrics, which may include minimum bandwidth and minimum link rate between each link among the two or more instances.

In this way, the service quality of the in-network computing service may be assured.

In an implementation form of the first aspect, the management device may be configured to obtain the configuration information by: receiving an instantiation request from an application service provider (ASP); and retrieving the configuration information based on the instantiation request.

Optionally, the application service provider may be a UE.

Optionally, the instantiation request may indicate which (edge) application service is to be “offloaded” to the network function entity. The management device may then be configured to retrieve the configuration information according to the indicated (edge) application service.

In an implementation form of the first aspect, before the one or more instances are instantiated on the network function entity, the management device may be further configured to allocate resources to the network function entity based on the configuration information.

In this way, resources (e.g., bandwidth, power, computational resources, etc.) may be utilized when the in-network computing service is to be consumed, and thus, resource utilization may be improved.

In an implementation form of the first aspect, the cellular network may comprise a 3GPP network.

The 3GPP network may refer to a communications network having a radio interface defined by 3GPP technical specification(s). The 3GPP network may be, for example, but not limited to, a 5G/6G mobile network, or any of their variants.

In an implementation form of the first aspect, the management device may comprise a network functions virtualization management and network orchestration (NFV-MANO) entity. The configuration information may comprise a network service descriptor (NSD).

In an implementation form of the first aspect, the NFV-MANO entity may comprise an NFV orchestrator (NFVO) and a catalog entity. The NFVO may be configured to: receive the NSD from an operations support system (OSS) and/or business support system (BSS); and send the NSD to the catalog entity.

It is noted that the OSS and/or BSS may sometime be referred to as “OSS/BSS” in the field of telecommunications.

In an implementation form of the first aspect, the catalog entity may be configured to: receive the NSD from the NFVO; and store the NSD in association with a catalog ID.

In an implementation form of the first aspect, the NFV-MANO entity may further comprise a virtual network functions manager (VNFM). The VNFM may be configured to: receive a deployment request from the NFVO, wherein the deployment request comprises the catalog ID; obtain the NSD from the catalog entity based on the catalog ID; and configure the one or more instances at the network function entity based on the NSD.

A second aspect of this disclosure provides a network function entity. The network function is for a core network of a cellular network and is configured to: receive, from a management device managing the core network, configuration information of an application service, wherein the application service comprises an in-network computing service; and instantiate one or more instances for performing the in-network computing service based on the configuration information.

In this way, processing tasks can start much earlier on the network function entity before arriving at an endpoint where an actual application server locates (e.g., the edge data network). Further benefits may include reducing the traffic volume in the cellular network, reducing service latency, and improving resource utilization of the cellular network.

In an implementation form of the second aspect, the network function entity may be configured to process user plane traffic by using the one or more instances.

In this way, user plane traffic (or user plane data) may be processed “on the fly” and resource utilization may be improved.

In an implementation form of the second aspect, the network function entity may be configured to: process the user plane traffic; and send the processed user plane traffic to an application server for further processing.

Optionally, the size of the user plane traffic may be reduced after being processed by the network function entity. In this way, data volume can be reduced and traffic congestion between the cellular network and an edge data network where the application server is deployed can be avoided. Moreover, the round-trip latency of the user plane traffic may be also reduced.

In an implementation form of the second aspect, the network function entity may be configured to: process the user-generated data to obtain a final result; and send the final result to a user entity (or a UE).

That is, the in-network computing service may be adapted to completely accomplish the task of the application server. In this way, full functionality of the application server may be fully integrated into the core network of the cellular network. Therefore, data processing can move even closer to the data generator. Hence, the efficiency of edge computing can be further increased.

In an implementation form of the second aspect, the cellular network may comprise a 3GPP network.

In an implementation form of the second aspect, the network function entity comprises a user plane function (UPF).

Optionally, the network function entity may be based on network function virtualization (NFV). Optionally, the network function entity may comprise one or more programmable network processing units (NPUs). The cellular network (or the operator of the cellular network) may program the network function entity by providing scripts. The scripts may be complied with, deployed, and executed on the network function entity based on the configuration information. In this way, the network function entity is able to process packets with a user-specific processing logic including the in-network computing. Therefore, it opens an opportunity of customizing a network infrastructure individually.

A third aspect of this disclosure provides a method for managing a core network of a cellular network. The method comprises the following steps: obtaining, by a management device, configuration information of an application service, wherein the application service comprises an in-network computing service; and providing, by the management device, the configuration information to a network function entity of the core network, wherein the configuration information is adapted to enable the network function entity to instantiate one or more instances for performing the in-network computing service.

In an implementation form of the third aspect, the configuration information may comprise one or more of: a quantity of the one or more instances required for performing the in-network computing service; and identification information of the application service.

In an implementation form of the third aspect, the configuration information may further comprise topology information of two or more instances for the in-network computing service.

In an implementation form of the third aspect, the step of obtaining the configuration information may comprise: receiving an instantiation request from an application service provider; and retrieving the configuration information based on the instantiation request.

In an implementation form of the third aspect, before the one or more instances are instantiated on the network function entity, the method may further comprise allocating resources to the network function entity based on the configuration information.

In an implementation form of the third aspect, the cellular network may comprise a 3GPP network.

In an implementation form of the third aspect, the management device may comprise an NFV-MANO entity. The configuration information may comprise an NSD.

In an implementation form of the third aspect, the NFV-MANO entity may comprise an NFVO and a catalog entity. The method may further comprise: receiving, by the NFVO, the NSD from an OSS/BSS; and sending, by the NFVO, the NSD to the catalog entity.

In an implementation form of the third aspect, the method may further comprise: receiving, by the catalog entity, the NSD from the NFVO; and storing, by the catalog entity, the NSD in association with a catalog ID.

In an implementation form of the third aspect, the NFV-MANO entity may further comprise a VNFM. The method may further comprise: receiving, by the VNFM, a deployment request from the NFVO, wherein the deployment request comprises the catalog ID; obtaining, by the VNFM, the NSD from the catalog entity based on the catalog ID; and configuring, by the VNFM, the one or more instances at the network function entity based on the NSD.

The method of the third aspect and its implementation forms may achieve the same advantages and effects as described above for the management device of the first aspect and its implementation forms.

A fourth aspect of this disclosure provides a method for a core network of a cellular network. The method comprises the following steps: receiving, by a network function entity from a management device of the core network, configuration information of an application service, wherein the application service comprises an in-network computing service; and instantiating, by the network function entity, one or more instances for performing the in-network computing service based on the configuration information.

In an implementation form of the fourth aspect, the method may further comprise processing, by the network function entity, user plane traffic by using the one or more instances.

In an implementation form of the fourth aspect, the method may further comprise: processing, by the network function entity, the user plane traffic; and sending, by the network function entity, the processed user plane traffic to an application server for further processing.

In an implementation form of the fourth aspect, the method may further comprise: processing, by the network function entity, the user-generated data to obtain a final result; and sending, by the network function entity, the final result to a user entity.

In an implementation form of the fourth aspect, the cellular network may comprise a 3GPP network.

In an implementation form of the fourth aspect, the network function entity comprises a UPF.

The method of the fourth aspect and its implementation forms may achieve the same advantages and effects as described above for the network function entity of the second aspect and its implementation forms.

A fifth aspect of this disclosure provides a system. The system comprises a management device according to the first aspect or any implementation form thereof, and at least one network function entity according to the second aspect or any implementation form thereof.

Optionally, when there are two or more network function entities in the system, the two or more network function entities may be cascaded to process the user plane traffic.

A sixth aspect of this disclosure provides a computer program comprising instructions which, when the program is executed by a computer, cause the computer to perform the method according to the third aspect or any of its implementation forms.

A seventh aspect of this disclosure provides a further computer program comprising instructions which, when the program is executed by a further computer, cause the further computer to perform the method according to the fourth aspect or any of its implementation forms.

An eighth aspect of this disclosure provides a non-transitory storage medium storing executable program code which, when executed by a processor, causes the method according to the third aspect or any of its implementation forms to be performed.

A ninth aspect of this disclosure provides a further non-transitory storage medium storing executable program code which, when executed by a further processor, causes the method according to the fourth aspect or any of its implementation forms to be performed.

It has to be noted that all devices, elements, units, and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF THE DRAWINGS

The above-described aspects and implementation forms will be explained in the following description of specific embodiments in relation to the enclosed drawings, in which:

FIG. 1 shows an example of a management device 100 and at least one network function entity 200 according to the present disclosure;

FIG. 2 shows an example of a system architecture according to this disclosure;

FIG. 3 shows an example of an IN-AL service onboarding procedure according to this disclosure;

FIG. 4 shows an example of an IN-AL service instantiation procedure according to this disclosure;

FIG. 5 shows a diagram of a method according to this disclosure; and

FIG. 6 shows a diagram of a further method according to this disclosure.

### DETAILED DESCRIPTION OF ILLUSTRATIVE EMBODIMENTS

A list of abbreviations used in this disclosure is provided as follows:
INC: in-network computing;
IN-AL: in-network application logic;
(E-)DN: (edge) data network;
MEC: multi-access edge computing;
MP: management plane;
CN: core network;
RAN: radio access network;
(E)AS: (edge) application service;
ASP: application service provider;
NS: network service;
NF: network function;
cNF: computing network function;
NSD: network service descriptor;
VNF: virtual network function;
UPF: user plane function;
NFV: network functions virtualization;
NFVI: NFV infrastructure;
NFVO: NFV orchestrator;
VNFM: virtual network functions manager;
VIM: virtual infrastructure manager;
EM: element manager; and
NFV-MANO: NFV management and orchestration.

The present disclosure generally provides an extension to a management plane of a mobile network (e.g., a 3GPP network) carrying new information, so as to facilitate a new procedure of instantiating in-network computing service(s) at one or more network function entities of the mobile network.

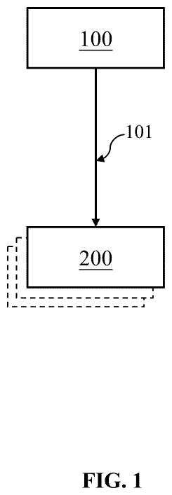

FIG. 1 shows an example of a management device 100 and at least one network function entity 200 according to the present disclosure.

The management device 100 is configured to obtain configuration information 101 of an application service. The application service comprises an in-network computing service. That is, the management device 100 is configured to obtain configuration information 101 of the in-network computing service.

The management device 100 is further configured to provide the configuration information 101 to a network function entity 200 of the core network. The configuration information 101 is adapted to enable the network function entity 200 to instantiate one or more instances for performing the in-network computing service in the core network.

It is noted that the application service, including the in-network computing service, is not a standard 3GPP service. The application service, including the in-network computing service, is rather defined by a corresponding application service provider. Therefore, the configuration information 101 may help to instantiate the in-network computing service at the network function entity 200, of which the core network itself has no knowledge of how to deploy the in-network service without the configuration information 101.

Optionally, the configuration information 101 may be carried by an NSD. The NSD is an information model introduced by ETSI for supporting network functions virtualization (NFV), e.g., since ETSI GR NFV-MAN 001 v.1.2.1 and in other related specifications. In the present disclosure, the NSD is extended with additional information elements, which may be used to carry the configuration information 101 of the in-network computing service. An example of the NSD according to this disclosure is specified in Table 1.

TABLE 1
NSD for in-network computing

| | | |
|---|---|---|
| Attribute | Value Type | Content |

All static attributes (e.g., nsdInfold, nsdId, name,
version, designer, nsd, vnfPkgInfoId, . . . )

| | | |
|---|---|---|
| EdgeAppId | Identifier | The ID value of the |
| | | associated edge application |
| | | service |
| InstanceNum | Integer | The number of instances |
| | | needed in order to fulfill the |
| | | requirement of the in- |
| | | network computing service |
| InstanceTopo | Graph (e.g., adjacent | The topology of instances of |
| | matrix) | the in-network computing |
| | | service with link |
| | | performance metrics |
| InterNFParams | List of key-value pairs | Intermediate parameters |
| | | exchanged between |
| | | connected INC instances |

It is noted that the names of the attributes in Table 1 are given as examples only, other names may also be used to define the attributes of the NSD.

Optionally, apart from the extended information elements, the in-network computing (or the IN-AL) service may share the same attributes of a normal network service (NS), e.g. a 3GPP service. It is noted that for a cellular network, a network service may be of different kinds. For instance, the network service may be a 3GPP service, which is standardized by 3GPP. Alternatively, the network service may be an application service, which is provided and/or specified by an application service provider. The application service is not a 3GPP service and is user-specific. The in-network computing (or the IN-AL) service in this disclosure is a specific kind of application service. The common attributes of the NSD in this disclosure may specify meta information such as the identifier, version, name, resource requirement, security configurations, and image (e.g., application scripts and/or virtual machine images and/or required software packages) of the IN-AL service. The IN-AL service may be a virtualized instance characterized by the NSD.

Optionally, unlike a conventional network service, the IN-AL service may not be independent, because the IN-AL service may be related to an existing (edge) application service located in an (edge) data network.

The EdgeAppId attribute in Table 1 may be used to indicate which (edge) application service the IN-AL service is associated with. Since the IN-AL aims to enhance the experience and performance of the existing (edge) application service, the attribute of EdgeAppId may be used to tell the core network (or the network operator) how the network function entity running the IN-AL service should be linked to the (edge) application service located in the (edge) data network.

The InstanceNum attribute in Table 1 may be used to indicate the number of instances required for realizing the IN-AL service. The InstanceNum attribute may be optional and may present when two or more instances are required. That is, when an (edge) application service of an (edge) data network requires only one instance, this attribute may be omitted. Correspondingly, by default, the network function entity may instantiate one instance if no InstanceNum is carried in the NSD. Optionally, when the (edge) application service of the (edge) data network requires two or more instances containing application-specific processing logic to realize a particular service, the InstanceNum is carried and its value may be greater than 1.

The InstanceTopo attribute may be used to indicate topological information of the required number of instances. For example, it may indicate how the instances shall be connected in order to form a particular service graph (a linear path, a tree, or a graph). The network operator has to refer to such a topology when deploying the required instances.

The InterNFParams attribute may be used to indicate what intermediate results are to be exchanged between instances. It may comprise a list of key-value pairs. In each entry of the list, the key may contain indices of a producing instance and a consuming instance, and the value may contain what parameter(s) will be produced from the producing instance and sent to the consuming instance.

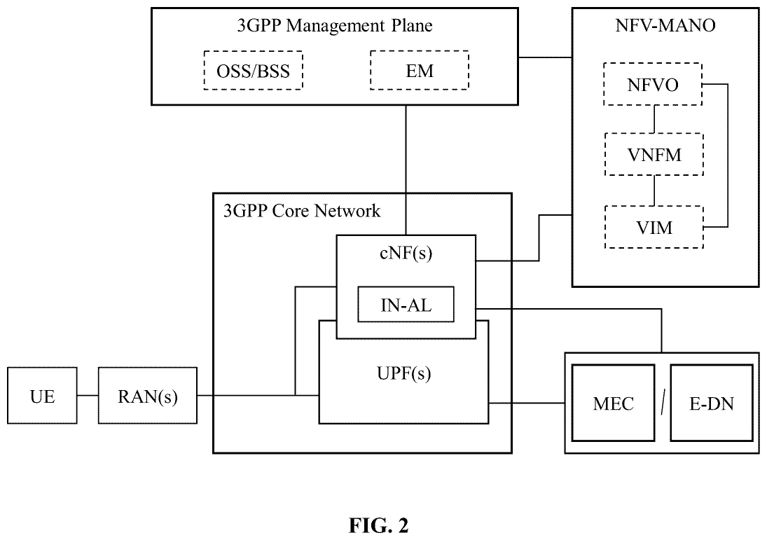

FIG. 2 shows an example of a system architecture according to this disclosure.

The system architecture shows exemplarily a cellular network architecture. The cellular network may comprise a management plane, a core network, and at least one radio access network. The cellular network may be internetworking with a data network. The data network may be used to deploy one or more application services for executing user-defined applications. When multi-access edge computing or edge computing is utilized in the data network, the data network may also be referred to as a multi-access edge computing network, or an edge data network.

The cellular network may be a 3GPP network. Correspondingly, the 3GPP network may comprise a 3GPP management plane, a 3GPP core network, and at least one radio access network. The 3GPP network may be a 5G/6G communication network. When the 3GPP network is a 5G network, the 3GPP core network may be referred to as a 5G core (5GC), or a 5G evolved packet core (EPC). The 3GPP management plane may comprise an OSS/BSS and an element manager (EM). The 3GPP core network may comprise one or more network function entities. A network function entity may also be referred to as a network element (NE), which may be a discrete network entity containing virtualized or non-virtualized network function (NF).

The system further comprises a management device (or management entity) for managing the core network. The management device corresponds to the management device 100 of FIG. 1 and may share the same features and functions likewise. Virtualization has been adopted in the 3GPP network. For example, a part or all of network function entities of the 3GPP core network may run virtualized network functions to support a variety of 3GPP services. For resource management of the virtualized 3GPP network, the management device may be an NFV management and orchestration (NFV-MANO) element. The NFV-MANO element is a key element of the ETSI NFV architecture. The NFV-MANO may be used to coordinate network resources for virtualized applications and the lifecycle management of virtual network functions (VNFs) and network services. The VNFs may be referred to as network functions that are based on virtualization technology. The NFV-MANO may include the following components: the NFV orchestrator (NFVO), the VNF manager (VNFM), and the virtual infrastructure manager (VIM). The NFV-MANO may be adapted to interact with the 3GPP management plane and the 3GPP core network through dedicated interfaces.

Normally, user-plane traffic (or user-plane data) may be generated at the UE or in the (edge) data network, travel through one or more UPFs of the 3GPP core network, and reach its destination (the data network or the UE). In this disclosure, the management device (e.g., the NFV-MANO) may obtain configuration information of an in-network computing service and provide the configuration information to a UPF. The in-network computing service may comprise IN-AL associated with an edge application service of an edge data network. The IN-AL may be adapted to (pre-)process the user-plane traffic at the core network. Thus, the in-network computing service may be seen as equivalent to the IN-AL service in this disclosure. The UPF equipped with the IN-AL may be generally referred to as a computing network function (cNF). That is, the cNF in this disclosure may be seen as an enhanced version of a UPF, which is adapted to run the IN-AL service. The cNF may correspond to the network function entity 200 of FIG. 1 and may share the same features and functions likewise. In this way, the edge application service may start processing user plane traffic in the core network, which is much earlier than processing in the data network. Moreover, the size of the user plane traffic may be further reduced after processing in the core network. Therefore, data volume can be significantly reduced and network congestion may be avoided.

Optionally, multiple cNFs may be used to run the in-network computing service. The multiple cNFs may be associated with an (edge) application service deployed in a data network (e.g., E-DN/MEC). Optionally, the cNF may act as two modes: an intermediate processing point, or a termination point of the associated application service. For the first mode, the cNF may be responsible for some preparation tasks for the application service. For the second mode, the cNF itself may provide full services to the UE. In the second mode, user plane traffic can terminate at the cNF, and does not need to reach the end server side of the (edge) data network. An application service provider may decide which mode to use or combine the two modes to design a specific IN-AL, taking characteristics of the application service, resource availability, and expected quality of service (QoS) of the application service into consideration. When multiple cNFs are used, the two modes may be used as a combination. For instance, a first cNF may be used as an intermediate processing point, and a second cNF following the first cNF and coupled to the first cNF may be used as a termination point. Alternatively, the second cNF may be used as a further intermediate processing point and transfer the processing result to the (edge) data network.

Optionally, the deployment of the IN-AL in the cellular network may comprise two stages. The first stage is IN-AL service onboarding, and the second stage is IN-AL service instantiation.

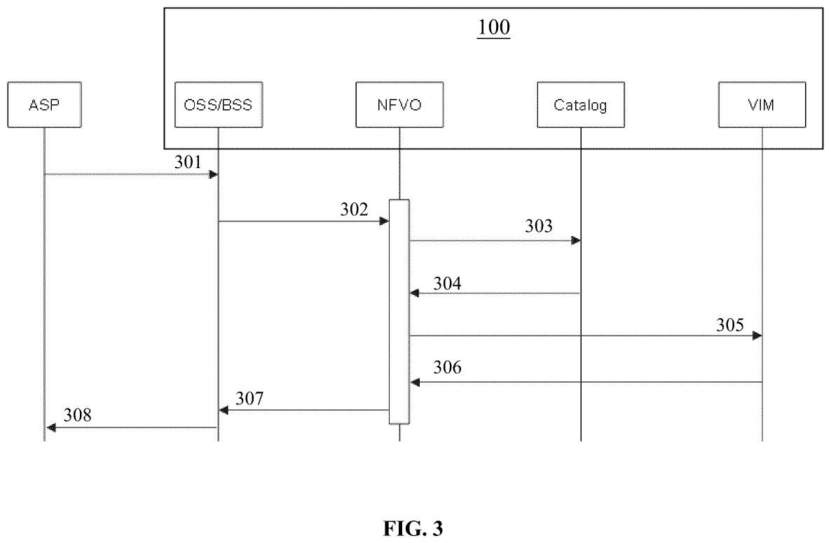

FIG. 3 shows an example of an IN-AL service onboarding procedure according to this disclosure.

It is noted that in this disclosure, the onboarding procedure is optional. The onboarding procedure is not essential and may be performed only once when the IN-AL service is to be deployed in a cellular network. The onboarding procedure may comprise the following steps.

Step 301: Submitting an onboard request.

In step 301, an ASP submits a request to onboard an IN-AL service for an application service. The NSD information may follow the attributes defined in Table 1. The request may be submitted to an OSS/BSS management entity.

Step 302: Validating the onboard request and onboarding the IN-AL NSD information.

In step 302, the OSS/BSS management entity receives the onboarding request and validates its meta information in order to check whether the ASP is allowed to make such a request. If validated, the OSS/BSS management entity forwards the request with the IN-AL NSD information as catalog data to an NFVO.

Optionally, the ASP may be a UE or a third party with respect to the network operator. Alternatively, the ASP and the OSS/BSS management entity may belong to the same operator. In this case, the onboard request may be directly submitted by the OSS/BSS management entity. This means that the (edge) application service may also be provided by the network operator, rather than a 3rd-party service provider that is independent of the network operator. In this case, validation is not needed.

Step 303: Sending a request notifying a catalog entity to store the IN-AL NSD information.

In step 303, the NFVO sends a request message to store the IN-AL NSD information as an IN-AL service catalog to a catalog entity. The request message contains the IN-AL NSD information specified in Table 1.

Step 304: Receiving a response that the IN-AL service catalog is stored.

In step 304, the catalog entity stores the IN-AL service catalog and sends a response to the NFVO about the status of the onboard event. The response may include an assigned catalog ID that can be used to retrieve the IN-AL NSD, a flag value indicating how the onboarding is finished, and other related information.

Step 305: Sending a request to upload a service package corresponding to the IN-AL service catalog.

In step 305, the NFVO sends a service package upload request to the VIM entity after the NFVO receives the response from the catalog entity when the onboarding is successful. The service package includes necessary image scripts for the IN-AL service. The image scripts can consist of multiple parts that can be instantiated with one or more instances when a deployment request is triggered. Different instances may form a certain IN-AL service topology where intermediate parameters and/or results have to be exchanged according to the attributes specified in Table 1.

Step 306: Receiving a response that the service package is uploaded.

In step 306, the NFVO receives a package upload response from the VIM with an uploading status. The status may include a flag value indicating how the uploading is finished, a package reference identifier, a hash value for later integrity checking, and related information.

Step 307: In response to the onboard request of steps 301 and 302, sending an onboard response.

In Step 307, the NFVO replies to the OSS/BSS with the status of the IN-AL service catalog onboarding request. The status may comprise the catalog ID, which may be used when triggering the IN-AL service.

Step 308: Acknowledgement of the onboard request.

In step 308, the OSS/BSS sends an acknowledgement message to the ASP with the status of the IN-AL catalog onboarding request.

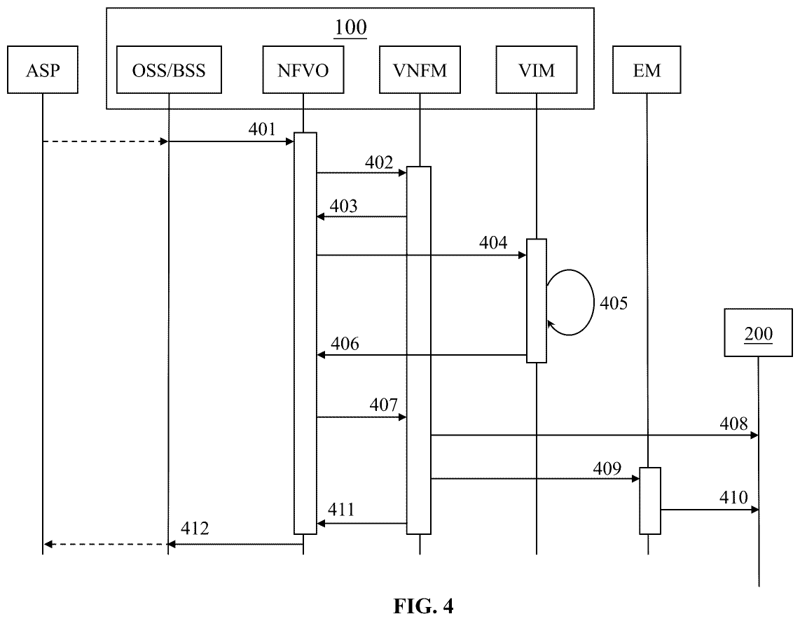

FIG. 4 shows an example of an IN-AL service instantiation procedure according to this disclosure.

The instantiation procedure may comprise the following steps.

Step 401: Sending, by an ASP (or OSS/BSS), an IN-AL service instantiation request.

In step 401, the ASP may send the IN-AL service instantiation request to OSS/BSS and further to an NFVO. Alternatively, the OSS/BSS may itself initiate sending the IN-AL service instantiation request to the NFVO. The request may comprise an identifier of the IN-AL service catalog referring to an application service (e.g., APP #1).

Optionally, the ASP may also be a UE if the IN-AL service catalog was prepared by the UE itself. For example, during the onboarding stage, the UE may upload an IN-AL catalog that was designed and developed according to Table 1.

The identifier of the IN-AL service catalog may be retrieved in several ways that can be either independent or dependent on the instantiation request procedure. In an independent way, the ASP may store the identifier of the IN-AL service catalog when onboarding this service. Alternatively, the ASP may ask for the identifier of the IN-AL service catalog from other parties where all onboarded catalogs are stored. For example, if the requested IN-AL service is not previously onboarded by the ASP itself, the ASP may query OSS/BSS or other ASPs.

Step 402: Deploying, by the NFVO, the IN-AL service for identified application service (e.g., APP #1).

In step 402, the NFVO may send an IN-AL service deployment request (e.g., for APP #1) to a VNFM. The deployment request may include the identifier of the IN-AL service catalog provided in the request from the OSS/BSS (or originally from the ASP).

Step 403: Allocating, by the VNFM, resources for the IN-AL service.

In step 403, the VNFM receives the deployment request and searches in a catalog entity with the identifier of the IN-AL service catalog. The VNFM may retrieve the resource requirements, for example, the required number of instances and resource specification for each instance listed in Table 1. The VNFM then may reply to NFVO about a resource allocation profile according to the existing status of a resource pool under the VNFM's management.

Step 404: Sending, by the NFVO, a deployment request with the resource allocation profile to a VIM.

In step 404, the NFVO may trigger the IN-AL service instantiation by sending the deployment request with the resource allocation profile provided from VNFM to the VIM.

Step 405: Allocating, by the VIM, resource of NFV infrastructure (NFVI) of the 3GPP domain; and attaching, by the VIM, each instantiated network function instance to the cellular network (more particularly, in the core network).

In step 405, the VIM receives the IN-AL service instantiation request and implements the prescribed resource allocation profile to the actual resource pool of the NFVI. The implementation of the prescribed resource allocation plan may include the following sub-tasks. The first task may be to realize the topology of the requested instances according to the InstanceTopo attribute defined in Table 1. This task may comprise provisioning resources (e.g., CPU, memory, and storage resources) in the resource pool for the required instances and connections among the instances according to the topology. The second task may be to configure the instantiated topology with requested parameters, such as link bandwidths, delays, and the like. The provisioning may be based on virtualization technology.

After this step 405, the network function entity 200 provisioned by the VIM may be seen as online or activated.

Step 406: Sending, by the VIM, an instantiation completion response to the NFVO.

Step 406 is optional, and the VIM may be configured not to send the instantiation completion response.

Alternatively, when the instantiation fails, the VIM may be configured to send a response with a status of the failed instantiation to the NFVO.

Step 407: Sending, by the NFVO to the VNFM, an acknowledgment message.

In step 407, the NFVO sends the acknowledgment message to VNFM indicating the completion of the requested IN-AL service instantiation with the prescribed resource allocation with the information of instantiated instances in the NFVI.

Step 408: providing, by the VNFM to the network function entity 200, configuration information of in-network computing service.

In step 408, the VNFM may configure the instance(s) of network function entity 200 with required configurations provided by the configuration information. The configuration information may be specific to an application layer and may comprise the attribute of InterNFParams in Table 1. The attribute InterNFParams may comprise information about what intermediate information is to be exchanged between the instances that are directly connected. The attribute InterNFParams may further indicate the roles of ingress and egress points of the instances. This configuration information may also comprise a reference point interfacing to an associated edge application service with the information specified by the attribute EdgeAppId in Table 1. For example, the configuration information may configure access information (e.g., IP address) of the associated edge application.

Alternatively, the instantiation in step 405 and the parameter configurations in step 408 may be done by a single entity, instead of being done in two separated steps from two different entities. The two steps can be done directly by the VIM if the InterNFParams information is available to the VIM.

Generally, since the OSS/BSS, the NFVO, the VNFM, and the VIM may be sub-units of an NFV-MANO entity, the NFV-MANO entity may be seen as a management device 100 of FIG. 1. In this disclosure, it can be understood that the instantiation and the parameter configuration of the network function entity 200 for running the in-network computing service are done by the management device 100 as a single entity.

Step 409: Notifying an element manager (EM), by the VNFM, the status of the launched instance(s).

In step 409, the VNFM may notify the EM about the instantiation and configuration status of the launched instances in the NFVI of the IN-AL service (e.g., for APP #1).

Step 410: Enrolling, by the EM, the instantiated instances.

In Step 410, the EM may enroll the instantiated instances of the IN-AL service (e.g., for APP #1) for management purposes.

Step 411: Sending, by the VNFM, a response of the completion of the instantiation.

In step 411, the VNFM may send to NFVO a response of the completion of the instantiation for IN-AL service.

Step 412: Sending, by the NFVO, a response of the completion of the instantiation.

In step 412, the NFVO may forward the response of the completion of the instantiation to the OSS/BSS and, optionally, further to the ASP.

Generally, since the NFVO, the VNFM, and the VIM may be sub-units of the NFV-MANO entity as the management device 100, steps 401-407 and 409-411 may be seen as internal procedures of the management device 100. Steps 401-407 and 409-411 are optional in this disclosure. Therefore, steps 401-407, and 409-411 may not be essential to the network function entity 200 for instantiating the in-network computing service. Step 409 merely discloses an interaction between the management device 100 and the management plane of the cellular network, while step 410 merely discloses an interaction between the network function entity 200 (or the core network) and the management plane of the cellular network. Therefore, steps 409 and 410 are also not essential for the management device 100 and the network function entity 200 for instantiating the in-network computing service. Step 408 may generally correspond to an interaction between the management device 100 and the network function entity 200 illustrated in FIG. 1.

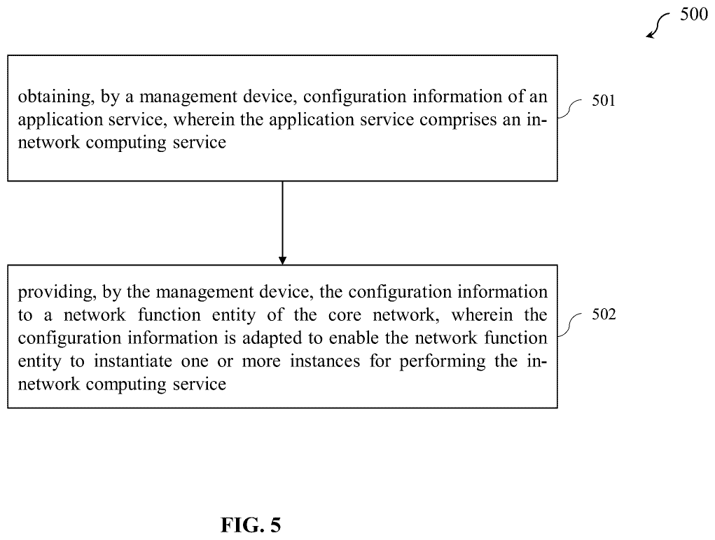

FIG. 5 shows a diagram of a method 500 according to this disclosure. The method 500 is for managing a core network of a cellular network and comprises the following steps: Step 501: obtaining, by a management device, configuration information of an application service, in which the application service comprises an in-network computing service; and Step 502: providing, by the management device, the configuration information to a network function entity of the core network, wherein the configuration information is adapted to enable the network function entity to instantiate one or more instances for performing the in-network computing service.

The steps of the method 500 may share the same functions and details from the perspective of FIG. 1-4 described above. Therefore, the corresponding method implementations are not described again at this point.

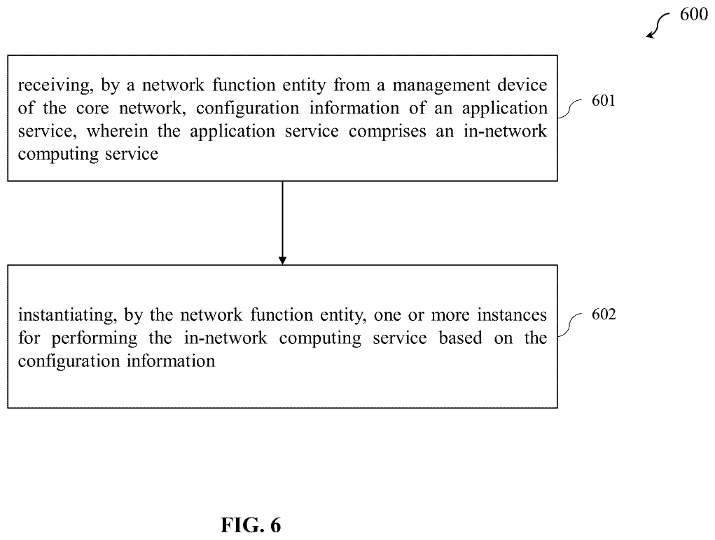

FIG. 6 shows a diagram of a further method 600 according to this disclosure. The method 600 is for a core network of a cellular network and comprises the following steps: Step 601: receiving, by a network function entity from a management device of the core network, configuration information of an application service, wherein the application service comprises an in-network computing service; and Step 602: instantiating, by the network function entity, one or more instances for performing the in-network computing service based on the configuration information.

The steps of the method 600 may share the same functions and details from the perspective of FIG. 1-4 described above. Therefore, the corresponding method implementations are not described again at this point.

In the present disclosure, the network function entity may be referred to as a network function element, or simply a network function. The configuration information adapted to enable the network function entity to instantiate one or more instances for performing the in-network computing service may be referred to as in-network application logic network service descriptor information (IN-AL NSDInfo). The IN-AL NSDInfo generally comprises an in-network computing service description for an edge application service. The in-network computing service description may allow a cellular network to support the instantiation of the in-network computing in the core network of the cellular network. By supporting onboarding and instantiation of an IN-AL service with the IN-AL NSDInfo, the management plane of a cellular network (e.g., 3GPP network) is enabled to deploy a network function instance that realizes in-network computing for an edge application service directly in its core network (e.g., 3GPP core network). Moreover, by comprising various configurations in the IN-AL NSDInfo, resources of the cellular network may be flexibly and efficiently utilized to deploy the in-network computing service for an edge application service.

In the present disclosure, the management device 100 may be referred to a collective of management units dedicated to different management and orchestration functions. For example, the management device 100 may comprise an OSS/BSS and/or an NFV-MANO. The NFV-MANO may comprise an NFVO, a VNFM, and a VIM. Any feature and function disclosed above with respect to any one of the OSS/BSS, the NFVO, the VNFM, and the VIM may be generally applied to the management device 100.

In the present disclosure, the device (i.e., the management device and the network function entity) may comprise at least one processor or processing circuitry (not shown) configured to perform, conduct or initiate the various operations of the device described herein. The processing circuitry may comprise hardware and/or the processing circuitry may be controlled by software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. The device may further comprise memory circuitry, which stores one or more instruction(s) that can be executed by the processor or by the processing circuitry, for example, under the control of the software. For instance, the memory circuitry may comprise a non-transitory storage medium storing executable software code which, when executed by the processor or the processing circuitry, causes the various operations of the device to be performed. In one embodiment, the processing circuitry comprises one or more processors and a non-transitory memory connected to the one or more processors. The non-transitory memory may carry executable program code which, when executed by the one or more processors, causes the device to perform, conduct or initiate the operations or methods described herein.

The present disclosure has been described in conjunction with various embodiments as examples as well as implementations. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. A device, comprising:
one or more processors; and
at least one non-transitory computer readable memory connected to the one or more processors and including computer program code for managing a core network of a cellular network, wherein the at least one non-transitory computer readable memory and the computer program code are configured, with the one or more processors, to cause the device to at least:
obtain configuration information of an application service, wherein the application service comprises an in-network computing service; and
provide the configuration information to a network function entity of the core network, wherein the configuration information is associated with enabling the network function entity to instantiate one or more instances for performing the in-network computing service.

2. The device according to claim 1, wherein the configuration information comprises one or more of:
a quantity of the one or more instances required for performing the in-network computing service; or
identification information of the application service.

3. The device according to claim 2, wherein the configuration information further comprises topology information of two or more instances for the in-network computing service.

4. The device according to claim 1, wherein obtaining the configuration information:
receiving an instantiation request from an application service provider; and
retrieving the configuration information based on the instantiation request.

5. The device according to claim 1, wherein the at least one non-transitory computer readable memory and the computer program code are configured, with the one or more processors, to further cause the device to allocate, before the one or more instances are instantiated, resources to the network function entity based on the configuration information.

6. The device according to claim 1, wherein the cellular network comprises a 3^{rd} generation partnership project network.

7. The device according to claim 6, wherein the device comprises a network functions virtualization management and network orchestration (NFV-MANO) entity, and the configuration information comprises a network service descriptor (NSD).

8. The device according to claim 7, wherein the NFV-MANO entity comprises a network functions virtualization (NFV) orchestrator (NFVO), and a catalog entity, wherein the NFVO is configured to:
receive the NSD from an operations support system (OSS) or business support system (BSS); and
send the NSD to the catalog entity.

9. The device according to claim 8, wherein the catalog entity is configured to:
receive the NSD from the NFVO; and
store the NSD in association with a catalog identity (ID).

10. The device according to claim 9, wherein the NFV-MANO entity further comprises a virtual network functions manager (VNFM), configured to:
receive a deployment request from the NFVO, wherein the deployment request comprises the catalog ID;
obtain the NSD from the catalog entity based on the catalog ID; and
configure the one or more instances at the network function entity based on the NSD.

11. A network function entity, comprising:
one or more processors; and
at least one non-transitory computer readable memory connected to the one or more processors and including computer program code for managing a core network of a cellular network, wherein the at least one non-transitory computer readable memory and the computer program code are configured, with the one or more processors, to cause the network function entity to at least:
receive, from a management device managing a core network of a cellular network with which the network function entity is associated, configuration information of an application service, wherein the application service comprises an in-network computing service; and
instantiate one or more instances associated with performing the in-network computing service based on the configuration information.

12. The network function entity according to claim 11, wherein the at least one non-transitory computer readable memory and the computer program code are configured, with the one or more processors, to further cause the network function entity to process user plane traffic by using the one or more instances.

13. The network function entity according to claim 12, wherein the at least one non-transitory computer readable memory and the computer program code are configured, with the one or more processors, to further cause the network function entity to:
send the processed user plane traffic to an application server for further processing.

14. The network function entity according to claim 12, wherein the at least one non-transitory computer readable memory and the computer program code are configured, with the one or more processors, to further cause the network function entity:
process user-generated data to obtain a final result; and
send the final result to a user entity.

15. The network function entity according to claim 11, wherein the cellular network comprises a 3^{rd} generation partnership project (3GPP) network.

16. The network function entity according to claim 11 wherein the network function entity comprises a user plane function.

17. A computer program product comprising a non-transitory computer-readable medium storing computer executable instructions for execution by a processor, wherein the instructions comprise:
instructions for:
obtaining, by a management device, configuration information of an application service, wherein the application service comprises an in-network computing service; and
providing, by the management device, the configuration information to a network function entity of a core network, wherein the configuration information is associated with enabling the network function entity to instantiate one or more instances for performing the in-network computing service; or
instructions for:
receiving, by a network function entity, from a management device of the core network, configuration information of an application service, wherein the application service comprises an in-network computing service; and
instantiating, by the network function entity, one or more instances associated with performing the in-network computing service based on the configuration information.
